(19) United States
(12) Patent Application Publication
(10) Pub. No.: US 2018/0018128 A1
(43) Pub. Date: Jan. 18, 2018

(54) MEMORY SYSTEM

(71) Applicant: SK hynix Inc., Gyeonngi-do (KR)

(72) Inventor: Tai Kyu KANG, Gyeonggi-do (KR)

(21) Appl. No.: 15/471,557

(22) Filed: Mar. 28, 2017

(30) Foreign Application Priority Data
Jul. 15, 2016 (KR) 10-2016-0090129

(51) Int. Cl. G06F 3/06

(52) U.S. Cl. CPC G06F 3/0653; G06F 3/0673; G06F 3/0659; G06F 3/061; G06F 3/0625; G06F 3/0652

(57) ABSTRACT

Provided herein is a memory device including a memory cell array, a peripheral circuit configured to perform a first operation for the memory cell array, and a control circuit configured to generate an operation status code and output the operation status code. The first operation includes a plurality of second operations that are successively performed. The operation status code indicates, among the plurality of second operations, a current operation that is being performed by the peripheral circuit.

### CROSS-REFERENCE TO RELATED APPLICATION

The present application claims priority under 35 U.S.C. §119(a) to Korean patent application number 10-2016-0090129 filed on Jul. 15, 2016, which is herein incorporated by reference in its entirety.

### BACKGROUND

### 1. Field

Various embodiments of the present disclosure relate to a memory device which generates and outputs an operation status code, a memory controller which controls the memory device based on the operation status code, a memory system including the same, and a method of operation thereof.

### 2. Description of Related Art

Memory systems are used widely as data storage devices for portable and non-portable electronic digital devices such as desktop computers, laptop computers, tablets, digital cameras, MP3 players, and smartphones. Typically, a memory system may include a memory device in which data are stored, and a memory controller configured to control the memory device. The memory controller may transmit a variety of information including commands and data between the electronic device hosting the memory device and the memory device.

In recent years, memory systems have been developed which employ a plurality of memory devices for satisfying consumer demand for higher data capacity electronic devices. The plurality of memory devices may be operated in parallel under the control of a memory controller. However, generally, such multi-memory device systems may suffer from unstable operation due to excess power consumption when a plurality of operations are performed simultaneously.

### SUMMARY

Various embodiments of the present disclosure are directed to an improved memory system including a memory controller and a plurality of memory devices which can operate simultaneously without a risk of unstable operation due to excessive power consumption. The controller of the memory system may more efficiently control performance of multiple operations among the memory devices based on operation status codes generated by the memory device.

One embodiment of the present disclosure provides a memory device including: a memory cell array; a peripheral circuit configured to perform an operation for the memory cell array the operation including a plurality of sub-operations; and a control circuit configured to generate an operation status code for the memory device and output the operation status, wherein the operation status code indicates, a current sub-operation that is being performed by the peripheral circuit.

Another embodiment of the present disclosure provides a memory device including: a memory cell array; a peripheral circuit configured to perform an operation for the memory cell array in response to a command; and a control circuit configured to generate an operation status code and output the operation status code in response to an operation status read command. The operation comprises a plurality of sub-operations that are successively performed. Every time each of the plurality of sub-operations is performed, the operation status code is changed to a value corresponding to a current sub-operation that is being performed.

Still another embodiment of the present disclosure provides a memory system including: a memory controller configured to output a first command and an operation status read command; and a first memory device configured to perform a first operation including a plurality of sub-operations that are successively performed in response to the first command, generate an operation status code indicating that any one of the plurality of sub-operations is being performed, and output the operation status code to the memory controller in response to the operation status read command.

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a diagram illustrating a memory system employing a controller and a plurality of memory devices, in accordance with an embodiment of the present disclosure;

FIG. 2 is a diagram illustrating a coupling relationship between a memory controller and a plurality of memory devices;

FIG. 3 is a detailed diagram illustrating an exemplary configuration of a plurality of coupling lines for the coupling relationship of FIG. 2;

FIG. 4 is a diagram illustrating an exemplary configuration of a memory device employed in the memory system of FIG. 1;

FIG. 5 is a diagram illustrating as an example a plurality of sub-operations and corresponding operation status codes for a program operation, in accordance with an embodiment of the present disclosure;

FIG. 6 is a diagram illustrating an exemplary configuration of a control circuit employed in the memory device of FIG. 4, in accordance with an embodiment of the present disclosure;

FIG. 7 is a diagram illustrating an operation of outputting an operation status code, in accordance with an embodiment of the present disclosure;

FIG. 8 is a diagram illustrating an exemplary configuration of a memory controller of a memory system, in accordance with an embodiment of the present disclosure; and

FIG. 9 is a diagram illustrating a computing system including a memory system, in accordance with an embodiment of the present disclosure.

### DETAILED DESCRIPTION

Hereinafter, embodiments will be described in greater detail with reference to the accompanying drawings. The present disclosure, however, may be embodied in various different forms, and should not be construed as being limited to the illustrated embodiments herein. Rather, these embodiments are provided as examples so that this disclosure will be thorough and complete, and will fully convey the various aspects and features of the present invention to those skilled in the art.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are simplified schematic illustrations of various embodiments and intermediate structures. As such, dimensions may be exaggerated for clarity of illustration and variations from the shapes of the illustrations as a result, for example, of manufacturing techniques and/or tolerances, are to be expected. Thus, the described embodiments should not be construed as being limited to the particular shapes of regions illustrated herein but may include deviations in shapes that result, for example, from manufacturing.

Like reference numerals in the drawings denote like elements.

Furthermore, unless defined otherwise, all the terms used in this specification including technical and scientific terms have the same meanings as would be generally understood by those skilled in the art to which the present invention pertains in view of the present disclosure. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component. Also, it will be understood that when an element is referred to as being “between” two elements, it can be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element (also referred to as a feature) described in connection with one embodiment may be used singly or in combination with other elements of another embodiment, unless specifically indicated otherwise.

Hereinafter, the various embodiments of the present invention will be described in detail with reference to the attached drawings.

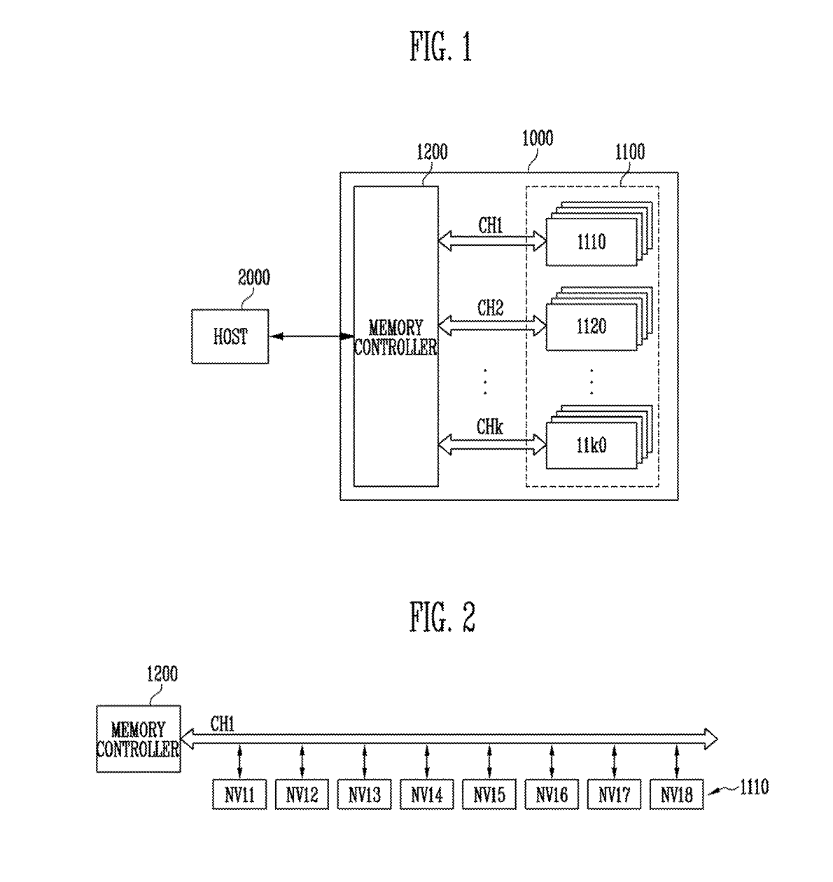

Referring now to FIG. 1, a memory system 1000 is provided, in accordance with an embodiment of the present disclosure.

Referring to FIG. 1, the memory system 1000 may include a memory device array 1100, and a memory controller 1200 which controls the memory device array 1100.

The memory device array 1100 may include a plurality of memory device groups 1110 to 11k0. The memory device groups 1110 to 11k0 may communicate with the memory controller 1200 through corresponding channels CH1 to CHk (k is a positive integer). Each of the memory device groups 1110 to 11k0 may include a plurality of memory devices for storing data.

The memory system may be operatively coupled to a host 2000. When a command is provided from the host 2000, the memory controller 1200 may control a plurality of the memory devices included in the memory device groups 1110 to 11k0 according to the provided command.

In order for the memory controller 1200 to control the memory devices, the memory controller 1200 may perform a status check operation of identifying which memory devices are available. For example, the memory controller 1200 may provide a status read command to the memory devices and identify which one is busy in operation or available based on ready/busy signals which are provided from the memory devices in response to the status read command. According to a result of the identification, the memory controller 1200 may select any one of the available memory devices, and then control the selected memory device such that the selected memory device performs an operation in response to a command provided from the host 2000.

Consequently, a plurality of memory devices may be in operation at the same time, i.e., in parallel. Thus, the respective memory devices which are in operation in parallel may each consume power. Each of the parallel operations of the plurality of the memory devices, may include a sub-operation that consumes a large amount of current. If these sub-operations are performed simultaneously may result in a high peak current consumption that may render unstable the power supply. As a result, an error may occur during an operation performed by the memory device or the memory controller 1200.

In accordance with an embodiment of the present disclosure, the memory controller 1200 may provide an operation status read command to each of the plurality of the memory devices of the memory system, receive operation status codes which are provided from the memory devices in response to the operation status read command, and then control the memory devices based on the operation status codes. Furthermore, the memory controller 1200 may identify sub-operations currently performed by the respective memory devices based on the operation status codes. The memory controller 1200 may check, through the operation status code received from a memory device which is in operation, whether the memory device is performing a sub-operation consuming a large amount of current. Moreover, the memory controller 1200 may control the memory devices to prevent them from performing at the same time sub-operations consuming a large amount of current thereby reducing the size of peak current consumed in the memory system.

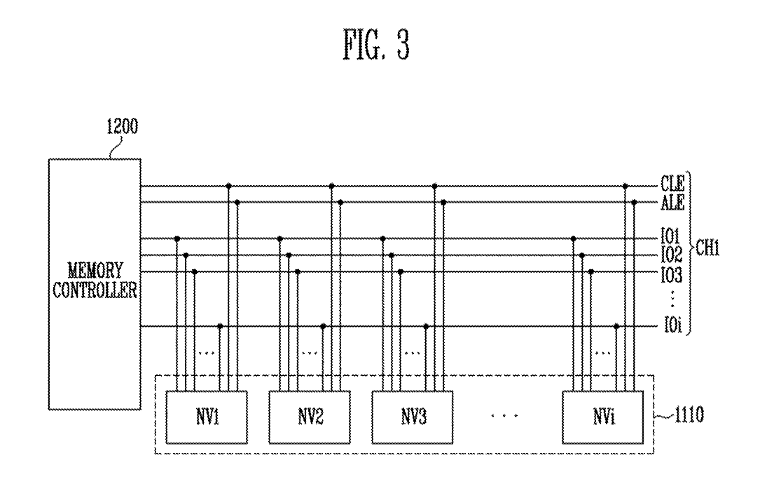

FIG. 2 is a diagram illustrating a coupling relationship between the memory controller 1200 and the memory devices of the memory device array 1100.

FIG. 2 illustrates the coupling relationship between the memory controller 1200 and the memory devices NV1 to NV8 of a first memory device group 1110 among the memory device groups 1110 to 11k0 shown in FIG. 1. The other memory device groups 1120 to 11k0 of FIG. 1 may also be coupled to the memory controller 1200 through channels in the same manner as that of the first memory device group 1110 shown in FIG. 2.

According to FIG. 2, the first memory device group 1110 may include a plurality of memory devices NV1 to NV8 which are coupled in common to the first channel CH1. Although, eight memory devices NV1 to NV8 are illustrated in FIG. 2, it should be understood that this is only an example provided for the sake of explanation. Depending on the configuration of the memory system, a smaller or a greater number of memory devices may be included in each memory device group of the memory device array 1100 of the memory system 1000. Each of the memory devices NV1 to NV8 may be a volatile memory device or a non-volatile memory device. For portable electronic devices, non-volatile memory devices which retain data even when power is cut off are preferred. For example, in an embodiment the memory devices NV1 to NV8 may be or include NAND flash memory devices.

The first channel CH1 may include a plurality of lines so that the memory controller 1200 and the memory devices NV1 to NV8 included in the first memory device group 1110 can transmit a variety of information through the first channel CH1. Detailed description will be made for the first channel CH1 with reference to FIG. 3.

FIG. 3 is a detailed diagram illustrating the coupling relationship of FIG. 2. FIG. 3 illustrates the memory devices NV1 to NV8 coupled to the first channel CH1.

Referring to FIG. 3, the first channel CH1 may include a line to which a command latch enable signal CLE is applied, a line to which an address latch enable signal ALE is applied, and a plurality of input/output lines IO1 to IO8.

Although not shown in FIG. 3, the first channel CH1 may further include lines to which a chip enable signal, a write enable signal, a read enable signal, and a write protect signal are respectively applied, as well as the above-stated lines. The command latch enable signal CLE may be used to select one of the memory devices NV1 to NV8, to which a command is provided. The address latch enable signal ALE may be used to select one of the memory devices NV1 to NV8, to which an address is provided. The read enable signal may be used to select one of the memory devices NV1 to NV8, from which data is read out. The write protect signal may be used to select one of the memory devices NV1 to NV8, which is protected from an abrupt program or erase operation.

A plurality of input/output lines IO1 to IO8 may couple the memory controller 1200 to the respective memory devices NV1 to NV8 of each memory device group. A command, an address and data may be transmitted from the memory controller 1200 to a selected memory device through a corresponding input/output line among the input/output lines IO1 to IO8 which is coupled to the respective memory devices NV1 to NV8. For instance, the command, the address or the data may be inputted to selected one or more of the memory devices NV1 to NV8 through the input/output lines IO1 to IO8 coupled in common to the respective memory devices NV1 to NV8.

An operation status read command may be transmitted from the memory controller 1200 to the memory devices NV1 to NV8 through the input/output lines IO1 to IO8. Operation status codes of the memory devices NV1 to NV8 may be transmitted from the memory devices NV1 to NV8 to the memory controller 1200 through the input/output lines IO1 to IO8.

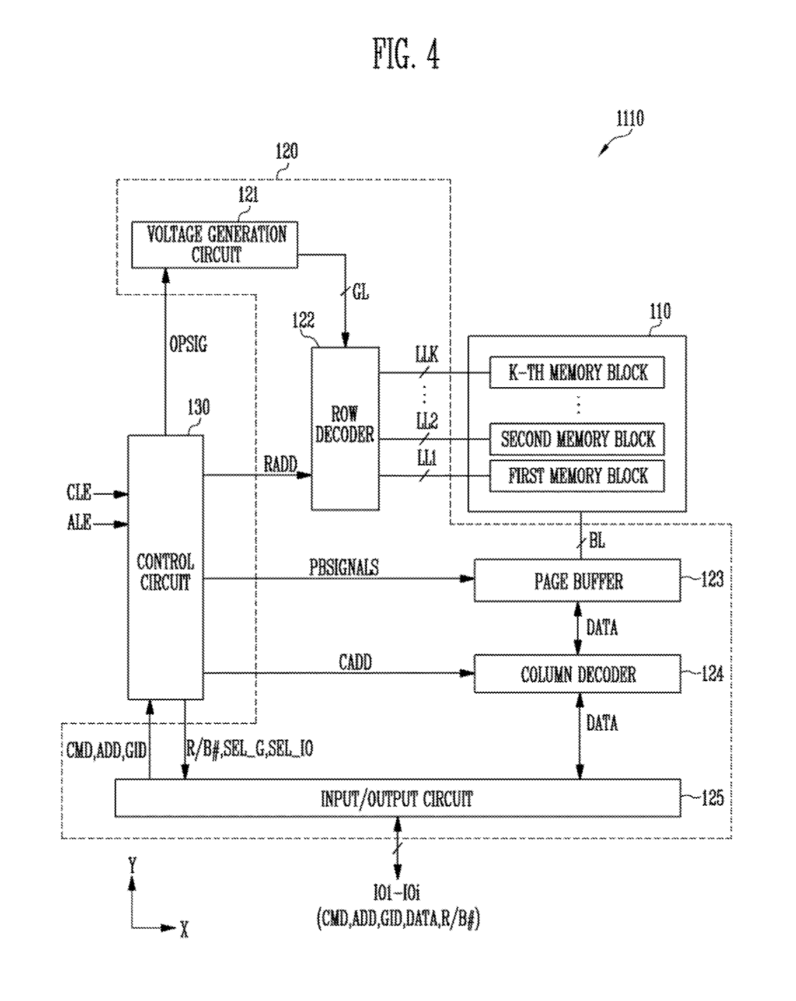

FIG. 4 is a diagram illustrating an exemplary configuration for a memory device 400 employed in any of the memory device groups of the memory device array 1100 of the memory system 1000 of FIG. 1. Since the memory devices included in the memory device array 1100 have the same or similar configuration, a first memory device NV1 among them will be described as an example.

Referring to FIG. 4, the memory device 400 may include a memory cell array 110 in which data is stored, a peripheral circuit 120 which is configured to perform a program operation, a read operation or an erase operation of the memory cell array 110, and a control circuit 130 which is configured to control the peripheral circuit 120.

The memory cell array 110 may include first to K-th memory blocks (K is a positive integer) having the same configuration. Each of the first to K-th memory blocks may have a two-dimensional or a three-dimensional structure. The two-dimensional structure refers to a structure in which memory cells are arranged in the horizontal direction on a semiconductor substrate. The three-dimensional structure refers to a structure in which memory cells are stacked in the vertical direction on the semiconductor substrate.

The peripheral circuit 120 may include a voltage generation circuit 121, a row decoder 122, a page buffer 123, a column decoder 124 and an input/output circuit 125.

The voltage generation circuit 121 may generate operating voltages having various levels in response to an operation signal OPSIG received from the control circuit 130. A program operation will be explained as an example. Accordingly, when a program operation signal OPSIG is received, the voltage generation circuit 121 may generate operating voltages having various levels such as a program voltage and a pass voltage required for the program operation. The operating voltages may be transmitted to the row decoder through one or more global lines GL.

The row decoder 122 may select one of the first to K-th memory blocks or a plurality of memory blocks in response to a row address RADD and transmit the operating voltages received through the global lines GL, to the selected one or more memory blocks through corresponding local lines LL1 to LLk which are coupled to the selected one or more memory blocks.

The page buffer 123 is coupled in common to plurality of memory blocks of the memory cell array 110 through a plurality of bit lines BL. In response to page buffer control signals PBSIGNALS received from the control circuit 130, the page buffer 123 may precharge the bit lines BL to a positive voltage, exchange data with selected memory blocks during the program or read operation, and temporarily store the received data.

The column decoder 124 may transmit data DATA between the page buffer 123 and the input/output circuit 125 in response to a column address CADD.

The input/output circuit 125 may receive a command CMD, an operation status read command and an address ADD from an external device, and transmit the command CMD, the operation status read command and the address ADD to the control circuit 130. The input/output circuit 125 may receive data DATA from an external device and may transfer the data DATA to the column decoder 124. In an embodiment, the external device may be the memory controller 1200. Furthermore, the input/output circuit 125 may transfer an operation status code from the control circuit 130 to the memory controller 1200.

The control circuit 130 may receive the command CMD and the operation status read command in response to a command latch enable signal CLE, and receive the address ADD in response to an address latch enable signal ALE. The control circuit 130 may perform various operations including program, erase and read operations in response to the received command CMD and address ADD.

During a normal operation, in response to a command CMD and an address ADD corresponding to a program, read or erase operation, the control logic 130 may output an operation signal OPSIG, a row address RADD, page buffer control signals PBSIGNALS and a column address CADD to control the peripheral circuit 120.

During an operation status check operation, the control circuit 130 may output an operation status code of the memory device 400 to the external device (e.g., memory controller 1200) through the input/output circuit 125 in response to the operation status read command provided from the external device through the input/output circuit 125.

The control circuit 130 may generate and store an operation status code for the memory device 400, and then output the stored operation status code to the memory controller 1200 through the input/output circuit 125 in response to an operation status read command received from the memory controller 1200. As a sub-operation that is being performed by the corresponding memory device 400 is changed, the operation status code may also be changed to a value corresponding to the changed sub-operation.

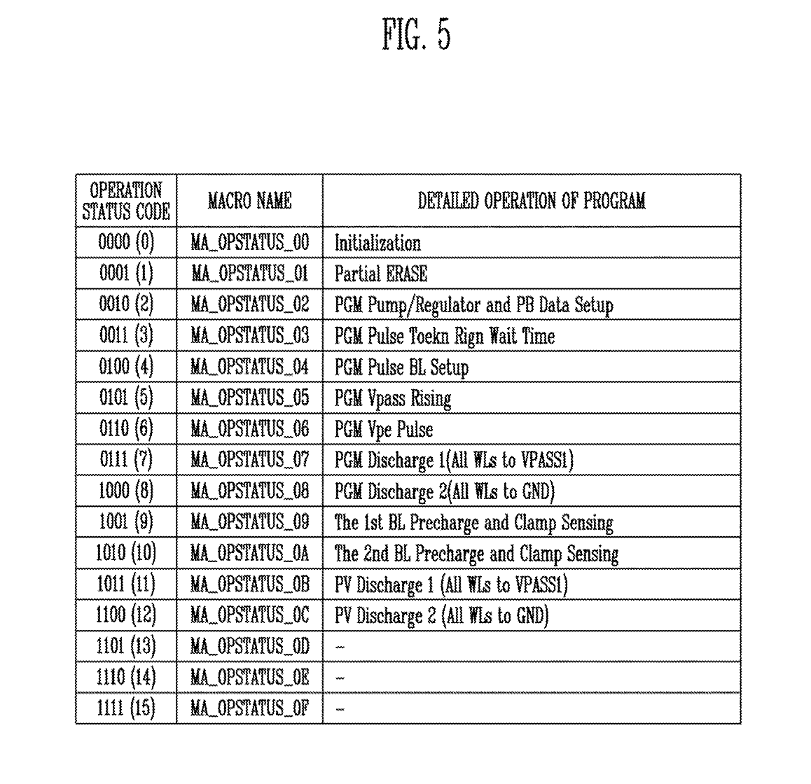

FIG. 5 is a diagram illustrating as an example a plurality of sub-operations and corresponding operation status codes in accordance with an embodiment of the present disclosure.

FIG. 5 illustrates, for example, a plurality of sub-operations (“SUB-OPERATION OF PROGRAM”) constituting a single program operation, and operation status codes corresponding thereto. For example, during a single program operation, the memory device may first perform an initialization operation (“Initialization”) and then perform a partial erase operation (“Partial Erase”). Subsequently, the memory device may perform a program pump/regulator and page buffer setup operation (“PGM Pump/Regulator and PB Data Setup”). As exemplified, the single program operation is formed of the entirety or some of the plurality of sub-operations. The single program operation is performed by successively performing the entirety or some of the plurality of sub-operations.

Referring to FIG. 5, each of a plurality of operation status codes (“OPERATION STATUS CODE”) corresponding to the respective sub-operations may be formed of a plurality of bits. FIG. 5 illustrates, for example, that an operation status code consists of four bits. The operation status code formed of four bits may be outputted through one of the input/output lines IO1 to IO8 by four cycles, or, alternatively, outputted through four of the input/output lines IO1 to IO8 by a single cycle. As a further alternative, the operation status code may be outputted through two of the input/output lines IO1 to IO8 by two cycles.

Each of a plurality of operation status codes corresponding to the respective sub-operations may be generated at a start time of the corresponding sub-operation. For example, when a program pass voltage rising operation (“PGM Vpass Rising”) starts, the operation status code may be changed from code ‘0100 (4)’ corresponding to a preceding program pulse bit line setup operation (“PGM Pulse BL Setup”) to code ‘0101 (5)’ corresponding to the program pass voltage rising operation (“PGM Vpass Rising”). The operation status code of ‘0101’ representing the program pass voltage rising operation (“PGM Vpass Rising”) may be maintained until a next period of a program pulse application operation (“PGM Vpe Pulse”) starts.

Each of the operation status codes may be generated in the middle of (i.e., during) the corresponding sub-operation. For example, the operation status code of ‘0110 (6)’ representing the program pulse application operation (“PGM Vpe Pulse”) may be generated a predetermined time after the start of the program pulse application operation (“PGM Vpe Pulse”). Alternatively, each of the operation status codes may be generated before the start of the corresponding sub-operation. For example, the operation status code of ‘0110 (6)’ representing the program pulse application operation (“PGM Vpe Pulse”) may be generated during the preceding program pass voltage rising operation (“PGM Vpass Rising”).

Among the plurality of sub-operations constituting the single program operation, the program pulse bit line setup operation (“PGM Pulse BL Setup”), a first bit line precharge and clamp sensing operation (“The 1st BL Precharge and Clamp Sensing”) or the like may consume a large amount of current. When a plurality of memory devices included in the memory system 1000 perform these large power consumption operations at the same time, a high peak current consumption may be momentarily caused, whereby the power of the memory system 1000 may become unstable, thus causing malfunction in the memory devices and the memory controller 1200. In accordance with an embodiment of the present disclosure, the memory controller 1200 may use the operation status codes to control the plurality of memory devices to prevent the sub-operations that consume a large amount of current from being performed at the same time. For instance, if the first memory device NV1 is performing a sub-operation that consumes a large amount of current, an operation to be performed by the second memory device NV2 may be delayed until the first memory device NV1 completes the sub-operation that consumes a large amount of current.

In the same manner as the program operation, each of the erase and read operations may be formed of a plurality of sub-operations. While each of the erase and read operations is performed, operation status codes corresponding to the respective sub-operations may be generated and stored.

FIG. 6 is a diagram illustrating an exemplary configuration of the control circuit 130.

According to the embodiment of FIG. 6, the control circuit 130 may include an operation status code generator 1301 and a register 132. For example, while the corresponding memory device performs a program operation, the operation status code generator 1301 may generate operation status codes respectively corresponding to the sub-operations constituting the program operation at the start of or during the respective sub-operations. The generated operation status codes may then be stored in the register 1302. The input/output circuit 125 may transfer the operation status read command from the external device (e.g., the memory controller 1200) to the register 1302 through the plurality of input/output lines IO1 to IO8. In response to the operation status read command, the register 1302 may output the stored operation status code to the input/output circuit 125. The input/output circuit 132 may transfer the operation status code to the external device through the plurality of input/output lines IO1 to IO8.

The operation status code generator 1301 may change a value of the operation status code according to a currently performed one among the plurality of sub-operations constituting the program operation. The operation status code generator 1301 may output the changed operation status code to the register 1302. Then, the register 1302 may replace a previously stored operation status code with the changed operation status code.

The operation status code generator 1301 may generate, in response to an operation status read command, an operation status code corresponding to a currently performed sub-operation. For example, while a plurality of sub-operations of the program operation are performed, the operation status code generator 1301 may not generate an operation status code until an operation status read command is inputted, but when an operation status read command is inputted, the operation status code generator 1301 may generate, in response to this, an operation status code corresponding to a sub-operation that is being performed at that time. For sub-operations that are performed since then, the operation status code may be automatically changed to a value corresponding to each sub-operation that is being performed. Alternatively, the operation status code may be maintained at the original value, and, when a new operation status read command is inputted, it may be updated to an operation status code corresponding to a sub-operation that is being performed at that time.

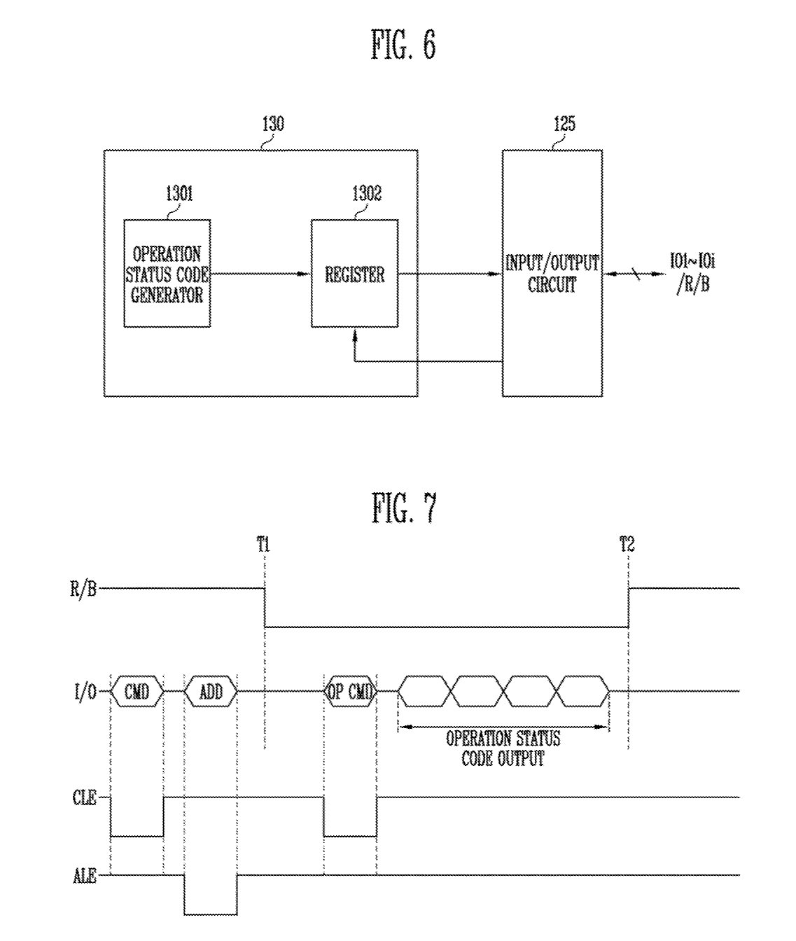

FIG. 7 is a diagram illustrating an operation of outputting an operation status code in accordance with the embodiment of the present disclosure.

Referring to FIGS. 1 and 7, the memory controller 1200 may transmit a command and an address to the memory device 1100 through the plurality of input/output lines IO1 to IO8. The command may be any one of a program command, an erase command or a read command. The memory device 1100 may receive the command from the memory controller 1200 while the command latch enable signal CLE is enabled, and receive the address while the address latch enable signal ALE is enabled. The memory device 1100 may perform a program, erase or read operation in response to the inputted command during a period from T1 to T2, and enable a ready/busy signal R/B to represent a busy status while performing a program, erase or read operation. While the memory device 1100 is performing a program, erase or read operation, the memory controller 1200 may input an operation status read command OP_CMD to the memory device 1200. The operation status read command OP_CMD may be the same as or different from a status read command. The memory device 1200 may output the ready/bush signal R/B representing the ready/busy status to the external device in response to the status read command. The input/output circuit 125 of the memory device 1100 may receive the operation status read command from the memory controller 1100 through the plurality of input/output lines IO1 to IO8 while the command latch enable signal CLE is enabled. The input/output circuit 125 may transmit the inputted operation status read command to the register 1302 during a period from T1 to T2. In response to the operation status read command provided from the input/output circuit 125, the register 1302 may output to the input/output circuit 125 the operation status code stored therein. The input/output circuit 125 may transfer to the memory controller 1200 the operation status code provided from the register 1302 through the plurality of input/output lines IO1 to IO8.

In an embodiment, the operation status code may be formed of a plurality of bits and outputted by a plurality of cycles. The operation status code may be outputted through one or more of the plurality of input/output lines IO1 to IO8. In another embodiment, the operation status code may be outputted through a plurality of input/output lines IO1 to IO8 by a single cycle.

For example, at a start time of each of sub-operations constituting the single program operation, the operation status code may be changed according to the starting sub-operations. That is, the operation status code may be changed several times during a single program operation. An operation status code outputted from the register 1302 in response to an operation status read command may correspond to a currently performed sub-operation at a time when the operation status read command is inputted. Thereafter, while the program operation is performed, the operation status code may be changed several times. In an embodiment, each changed operation status code may be outputted in response to each operation status read command. In another embodiment, each changed operation status code may be automatically outputted in response to the initially inputted operation status read command until the program operation is completed. Alternatively, only when an operation status read command is inputted may the operation status code be generated in response to this.

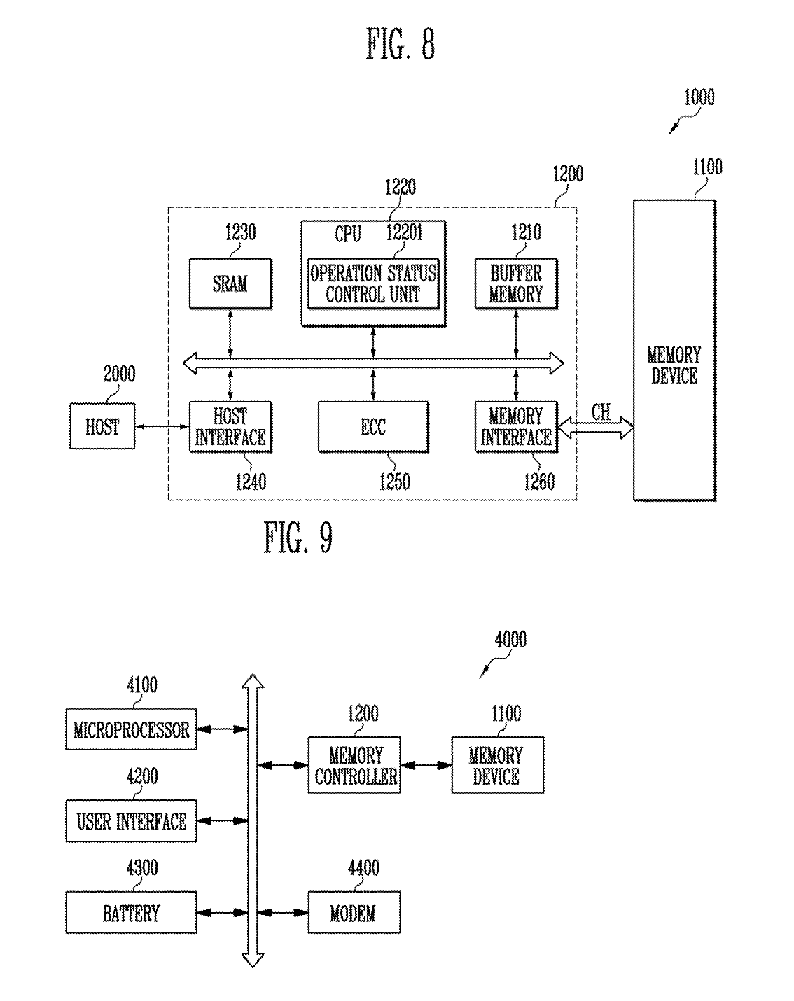

FIG. 8 is a diagram illustrating the memory controller in accordance with an embodiment of the present disclosure.

Referring to FIG. 8, the memory system 100 may include a memory device array 1100 in which data is stored, and a memory controller 1200 which controls the memory device array 1100. The memory controller 1200 may control communications between the host 2000 and the memory device 1100. The memory controller 1200 may include a buffer memory 1210, a CPU 1220, an SRAM 1230, a host interface 1240, an error correction code (ECC) unit 1250, and a memory interface 1260. Furthermore, in the memory controller 1200, the buffer memory 1210 may temporarily store data while the memory controller 1200 controls the memory device array 1100 and store a variety of information required for the operation of the memory controller 1200. For example, the buffer memory 1210 may store matching information between the plurality of the input/output lines and the plurality of the memory devices of the memory device array 1100 which are required for the status check operation.

The CPU 1220 may perform various operations for controlling the memory device array 1100 or generate a command and an address. The CPU 1220 may include an operation status control unit 12201. The operation status control unit 12201 may receive operation status codes from the entirety or some of the memory devices of the memory device array 1100 and control the operations of the entirety or some of the first to based on the received operation status codes. For example, when a command is inputted from the host 2000, if a sub-operation indicated by an operation status code inputted from the first memory device NV1 is an operation that consumes a large amount of current, the time at which the entirety or some of the remaining memory devices start operations corresponding to the command inputted from the host may be delayed for a period until the first memory device completes the operation that consumes a large amount of current. Alternatively, based on operation status codes inputted from the plurality of the memory devices, the plurality of the memory devices may be controlled such that they are prevented from simultaneously performing sub-operations that consume a large amount of current. In this manner, the memory controller 1200 by using the operation status codes from the various memory devices may control the performance of sub-operations in the plurality of memory devices such that a peak current that is simultaneously consumed by the plurality of the memory devices is lower than a reference level.

As a result, a peak value of current that is consumed by the entirety of the memory system 100 may be reduced, whereby the power of the memory system may be stably maintained.

The SRAM 1230 may be used as a working memory of the CPU 1220.

The host interface 1240 may include a data exchange protocol of the host 2000 coupled to the memory system 3000.

The ECC 1250 may detect and correct an error in data read from the memory device 1100.

The memory interface 1260 may provide an interface between the memory device array 1100 and the memory controller 1200. The memory interface 1260 may be coupled to the memory device array 1100 through a plurality of channels CH. The memory device array 1100 may be configured as in the embodiment of FIG. 1.

FIG. 9 is a view illustrating the schematic configuration of a computing system including a memory system in accordance with an embodiment of the present disclosure.

Referring to FIG. 9, a memory system 4000 in accordance with an embodiment of the present invention may include the memory device array 1100, the memory controller 1200, a microprocessor 4100, a user interface 4200, and a modem 4400 that are electrically coupled to a bus. If the computing system 4000 in accordance with the present embodiment is a mobile device, the memory system 4000 may further include a battery 4300 for supplying an operating voltage of the memory system 4000. Although not shown, the memory system 4000 in accordance with the present embodiment may further include an application chip set, a camera image processor (CIS), a mobile DRAM, or the like. The memory controller 1200 and the memory device array 1100 may form a solid state drive/disk (SSD). The memory device array may be configured as in the embodiment of FIG. 1. The memory controller 1200 may be configured as in the embodiment of FIG. 8.

The memory system 4000 in accordance with the present embodiment may be mounted using various types of packages. For example, the memory system 4000 in accordance with the present embodiment may be packaged using packages such as a package on package (PoP), ball grid arrays (BGAs), chip scale packages (CSPs), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flatpack (TQFP), a small outline (SOIC), a shrink small outline package (SSOP), a thin small outline (TSOP), a system in package (SIP), a multi-chip package (MCP), a wafer-level fabricated package (WFP), a wafer-level processed stack package (WSP), etc.

As described above, according to the present disclosure, a controller may check the status of a sub-operation that is performed in a memory device, and reduce a peak current that is consumed in the memory device. Thereby, the performance and reliability of the memory system can be improved.

Example embodiments have been disclosed herein, and although specific terms are employed, they are used and are to be Interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A memory device comprising:
a memory cell array;
a peripheral circuit configured to perform an operation for the memory cell array the operation including a plurality of sub-operations; and
a control circuit configured to generate an operation status code for the memory device and output the operation status,
wherein the operation status code indicates, a current sub-operation that is being performed by the peripheral circuit.

2. The memory device according to claim 1, wherein the operation comprises any one of a program operation, a read operation or an erase operation.

3. The memory device according to claim 2, wherein the control circuit comprises:
an operation status code generator configured to generate the operation status code; and
a register configured to receive the operation status code from the operation status code generator and store the operation status code.

4. The memory device according to claim 3, wherein the peripheral circuit comprises an input/output circuit configured to transfer an operation status read command from an external device to the register, and transfer the operation status code from the register to the external device.

5. The memory device according to claim 4, wherein the register outputs the operation status code to the input/output circuit in response to the operation status read command.

6. The memory device according to claim 1, wherein the operation status code comprises a plurality of bits.

7. The memory device according to claim 6, wherein the input/output circuit transfers the operation status code to the external device by a plurality of cycles through one or more of a plurality of input/output lines.

8. The memory device according to claim 2, wherein the operation status code generator changes the operation status code to a value corresponding to the current sub-operation at a start of the current sub-operation.

9. The memory device according to claim 8, wherein the register replaces a currently stored operation status code with the changed operation status code.

10. The memory device according to claim 1, wherein the control circuit outputs the operation status code a ready or busy signal in response to a status read command.

11. A memory device comprising:
a memory cell array;
a peripheral circuit configured to perform an operation for the memory cell array in response to a command; and
a control circuit configured to generate an operation status code and output the operation status code in response to an operation status read command,
wherein the operation comprises a plurality of sub-operations that are successively performed, and
wherein, every time each of the plurality of sub-operations is performed, the operation status code is changed to a value corresponding to a current sub-operation that is being performed.

12. The memory device according to claim 11, wherein the command comprises a program command, and the operation comprises a program operation.

13. The memory device according to claim 12, wherein the plurality of sub-operations include a program pulse bit line setup operation.

14. The memory device according to claim 11, wherein the operation status code is changed at a time at which each of the plurality of sub-operations starts.

15. The memory device according to claim 11, wherein the operation status code comprises a plurality of bits.

16. A memory system comprising:
a memory controller configured to output a first command and an operation status read command; and
a first memory device configured to perform a first operation including a plurality of sub-operations that are successively performed in response to the first command, generate an operation status code indicating that any one of the plurality of sub-operations is being performed, and output the operation status code to the memory controller in response to the operation status read command.

17. The memory system according to claim 16, further comprising a second memory device coupled to the memory controller.

18. The memory system according to claim 17, wherein the memory controller controls the second memory device based on the operation status code provided from the first memory device.

19. The memory system according to claim 18, wherein the memory controller delays application of a second command to the second memory device in response to the operation status code provided from the first memory device.

20. The memory system according to claim 18, wherein the memory controller uses the operation status code such that a peak current that is simultaneously consumed by the first and second memory devices is lower than a reference level.
